(19) United States
(12) Patent Application Publication
(10) Pub. No.: US 2013/0085770 A1
(43) Pub. Date: Apr. 4, 2013

(54) Qualifying Raters for Clinical Trials

(71) Applicants: Dave Young, Tucson, AZ (US); Alden Meier, Woodland Hills, CA (US)

(72) Inventors: Dave Young, Tucson, AZ (US); Alden Meier, Woodland Hills, CA (US)

(21) Appl. No.: 13/622,519

(22) Filed: Sep. 19, 2012

Related U.S. Application Data
(60) Provisional application No. 61/626,131, filed on Sep. 21, 2011.

(51) Int. Cl. G06F 19/00

(52) U.S. Cl. CPC G06F 19/363
USPC 705/2

(57) ABSTRACT

The invention provides an efficient approach to qualifying raters to serve in a clinical trial or study, where efficiency includes all aspects pertinent to study raters: creating of qualification profile; identification of appropriate study sites and raters, selection, training, and supplemental qualification of raters during the course of a clinical study or trial, as may be necessitated by study protocol changes or other changes that may occur.

### RELATED APPLICATIONS

This application is related to and claims priority from U.S. provisional application 61/626,131, by the same inventors, filed Sep. 21, 2011, the entirety of which is incorporated by reference as if fully set forth herein. The application is also related to U.S. application Ser. No. 12/228,952, U.S. application Ser. No. 12/449,791, U.S. application Ser. No. 12/452,363 the entirety of each of which is incorporated by reference as if fully set forth herein. This application is further related to U.S. provisional applications 61/595,613 and 61/595,378 the entirety of each of which is incorporated by reference as if fully set forth herein.

### GOVERNMENT FUNDING

None

### FIELD OF USE

The invention relates to clinical trials, and more specifically to qualifying raters for clinical trials.

### BACKGROUND

A rating scale is an assessment tool that is used on clinical trials and studies to obtain information regarding treatment response for subjects who are participating in the trial. Rating scales present the subject with an item and require them to select a response to the item from a number of choices. The rating scale has characteristics that are similar to a multiple choice test but differs in that the available options are designed to allow degrees of response for a specific item. There are many different rating scales that are used on clinical trials and clinical studies. The clinical trial or study personnel responsible for administering these rating scales are known as “raters”. More information can be found by referring to “A New Approach to Rater Training and Certification in a Multicenter Clinical Trial”, Journal of Clinical Psychopharmacology, Volume 25, Number 5, October 2005 Kenneth A. Kobak, PhD, Joshua D. Lipsitz, PhD, Janet B. W. Williams, DSW, Nina Engelhardt, PhD, and Kevin M Bellews, M S.

Raters are required to meet specific qualification requirements in order to be eligible to participate in any given clinical trial or study. Rater qualification requirements include not only minimum education levels, but also may include related work experience as well as specific experience administering the rating scale selected for use in a given clinical trial or study. These rater qualifications are different for each rating scale. A further complexity is that the qualification requirements for a rating scale may be different for each country or region in which the clinical trial may be operating.

Before an individual rater can participate in a clinical trial or study, his or her qualifications must be verified, specifically the rater qualifications requirements pertinent to the specific rating scale to be used in the clinical trail or study. According to current practice, potential raters who wish to participate in any given clinical trial or study must apply to the clinical trial or study trial team. Raters submit their qualifications, typically via fax or email. Submissions from raters are then collected and reviewed by the clinical trial team, and a rater's application to participate is either approved or denied. In some cases, exemptions to the rater qualification requirements are granted where the trial team feels that the individual is qualified to do the rating, despite a deficiency in one or more of the required rater qualifications. The determination of whether or not to grant exemptions is up to the clinical trial or study team. However, the decision can be deferred to an independent expert or a group of experts who determine whether or not to allow the rater to participate in the trial.

All of the above is done prior to the training of the qualified raters who have been selected for the trial. In most, if not all cases, regardless of qualifications, the raters must still receive scale training for the trial. Scale training is targeted at the trial specific use of the rating scale, providing raters the context needed in order to successfully perform ratings for the trial.

While much attention has been placed on training raters to participate in clinical trials, almost no effort has been expended in improving the qualification and selection of raters for clinical trials.

Currently, rater qualification for clinical trials is performed manually. This results in missing or incomplete records for raters who are participating or have participated on clinical trials. This incomplete audit trail can result in significant liability to the trial sponsor should any questions arise about the quality of the ratings performed during the trial or the qualifications of rater performing those ratings.

Individual trial teams evaluate rater qualifications for each clinical trial and every trial team may not apply the same standards in the review process. For example, exemptions may be granted by a particular trial team for raters who should not be included in the trial, and who would not have been included if they were assessed in a more rigid evaluation. This results in inconsistent rater qualification standards across studies and across the enterprise. Inconsistencies in rating subjects response to treatment undermine the legitimacy of the clinical trial results, putting at risk vast amounts of resources devoted to the test, and possibly even jeopardizing public health.

From the foregoing, it can be appreciated that in addition to being fraught with inconsistencies, the current manual evaluation methods are extremely labor intensive. In light of the ever increasing demand for better clinical trials, and more testing before drug approvals, what is needed is a way to reduce the time needed to identify and qualify train raters for a clinical trial or study. To the degree that such a time saver in selecting and qualifying raters is also compatible with a way to supervise, track and audit rater performance, and store rater information for use in other clinical trials, then such a solution would be of great benefit.

What is needed is a standardized system for selecting and qualifying raters for clinical trials. What is also needed is a means to automate as much as possible the rater selection and qualification process, including application of the equivalent of human leeway when assessing adequacy of less than perfect requirement satisfaction. What is further needed is a rater selection and qualification system that provides uniformity of rater qualifications for all sites of a clinical trial. Also needed is a means to collect and retain rater qualification information, including any exemptions granted by a trial team or rater qualification review board. Ideally, an overall efficient and reliable system for handling clinical trial rater identification, selection, training delivery and documentation, as well as performance data would be a boon to the smooth and rapid launching and auditing of clinical trials and studies around the world.

### BRIEF SUMMARY OF THE INVENTION

The invention taught herein satisfies at least the needs listed hereinabove. The invention provides an efficient approach to qualifying raters to serve in a clinical trial or study, where efficiency includes all aspects pertinent to study raters: creating of qualification profile; identification of appropriate study sites and raters, selection, training, and supplemental qualification of raters during the course of a clinical study or trial, as may be necessitated by study protocol changes or other changes that may occur. A system according to the invention provides dynamic tracking of every phase of the clinical trial or study and, as it pertains to raters, minimizes any delays associated with raters as required by the study. Further, the inventive system provides for standardization of each aspect of rater qualification and performance, and where each aspect may be tracked, documented, and stored for later scrutiny.

The invention provides a means of selecting and qualifying raters for clinical trials, where such selection and qualifying is substantially automated. It can be appreciated and does not require detailed elaboration, that fundamental aspects of a computer enabled system include at least one central processing unit (CPU), networked computer input and output devices, as well as memory and data storage in communication with the CPU. Moreover, the invention includes computer implementable instructions which are implementable by the at least one CPU.

In the preferred embodiment, a computer enabled system provides for rapid creation and deployment of a clinical study rating requirement profile (SRRP) and qualification requirements for raters. A system according to the invention provides for dissemination of requirements electronically, rater information input,

The invention provides standardized rater qualification evaluation by an automated system, where said system eliminates or at least reduces the variability and randomness inherent with the current manual process of subjective evaluation across trial teams.

The system provides classifications that further reduce the manual effort required to make a final evaluation. If an applicant rater is clearly not qualified to participate in the clinical trial or study based on the standard qualification criteria, the trial or study team can be spared any time that would be consumed with even a cursory manual review.

However, it is vital to the goal of rapidly filling a cohort of raters sufficient for the study or trial to proceed that the System intelligently applies tolerances, and generates metrics to arguably under-qualified raters so as to include as many raters as possible as potentially qualified. By assessing how close an applicant rater is to meeting the scale requirements, and assigning such an under-qualified rater a specific task that, when completed, renders that rater acceptable to participate the System intelligently maximizes resources while uniformly applying rater evaluations across all geographies. The System in a practical sense substitutes for human judgment of potentially viable near cases, by generating additional metrics in a consistent manner so uniformity of rater qualification is achieved. Moreover, the System achieves superior enrollment of raters with a substantial saving of administrative time, and increases the probability of an expedited clinical trial or study launch.

Toward this end, the inventive system may be programmed with thresholds that allow an applicant rater to continue through to the manual evaluation process if the applicant-rater credentials are within a specified range of being fully qualified. These tolerances aid in preserving the number of potentially qualified applicant raters while serving to maintain demonstrable homogeneity of qualification standards applied to the rater pool over geographic regions.

In addition, the System can generate a requirement to marginally qualified raters, requiring a qualification test to be taken by marginally qualified raters to assess their capabilities using the specific rating scale and perhaps allow them to continue in the process if they pass the test. The System can select from an assortment of qualifying tests, titrated to the specific degree the applicant rater needs to supplement his or her competencies to satisfy the scale requirements. Consequently, more applicant raters can rapidly complete specific modularized metrics, resulting in an even more efficient assemblage of raters sufficient to launch the trail or study.

It can be appreciated that the System tracks and stores all activities intermediated by the System. Thus, for example, storing rater qualification attempts and results provides a view into the status of rater selection for the trial teams as well as for the enterprise. It follows that rater qualifications can be reviewed and re-used across studies eliminating the need to re-qualify, for example, raters who work on multiple clinical trials for the trial teams. Stored rater profiles further aid in the recruitment of raters, thereby introducing further efficiencies and time savings to launching a clinical trial.

Trial sponsors, too, benefit from the capturing and storing credentials for raters online. The inventive System allows the data to be consolidated and made easily accessible by all participating groups and stakeholders. Providing real-time visibility into rater qualification gives the trial team and the trial sponsor much better control over the entire process.

Not insignificantly, in cases where the clinical trial protocol undergoes a change, or a change is being considered, the impact on raters, and the costs associated with the protocol change (ex. additional rater training, loss of some percentage of raters rendered unqualified owing to protocol change), the System empowers the decision makers to use the System to see the full implications of the protocol change, and plan accordingly. It can be appreciated that the full auditability of the System provides greater levels of certitude to trial sponsors.

### BRIEF DESCRIPTION OF THE DRAWINGS

FIG. 1 is a flow chart depicting the process of qualifying raters according to an embodiment of the invention.

### DETAILED DESCRIPTION OF A PREFERRED EMBODIMENT

Notes on terminology. While every attempt has been made to limit the use of acronyms peculiar to clinical trials, those that are used are explained either in this specification, or in the related cases incorporated by reference as if fully set forth herein. As used herein, clinical trial or study may be referred to simply as a “trial”. Similarly, “trial team” means clinical trial or study team. “Site” means “study site”. Trial sponsor refers to the entity sponsoring the clinical trial or study, and may be a pharmaceutical company, for example. “Qualifications” generally means “rater qualifications”, unless it is clear from the context that this is not the case. “System” refers to the inventive system—a system performing the inventive method—, including at least one server and central processing unit, CPU, and in communication with the CPU user devices, memory and storage devices, and computer implementable instructions and logic sufficient to perform the indicated tasks. Recitation of system components is not exhaustive, as implementations of tasks set forth in the method herein may assume countless configurations, both in the component devices and in the instructions related to the interoperability of the devices.

According to the invention, when a clinical trial is to be launched, the trial team sets up a Study Rating Requirements Profile, sometimes referred to herein as SRRP. The Study Rating Requirements Profile contain all of the rating scales to be used in the trial along with the associated rater qualification requirements for the rating scales. In the event that rater qualification requirements have already been established—either by another trial team or by a centralized body within the trial sponsor—the System enables the trial team to use pre-established rater qualifications “as-is” or to use any pre-established as a baseline allowing some modifications that are better suited to the use of the scales on the trial.

In addition, the Study Rating Requirements Profile contains the number of sites and raters that are needed to conduct the trial. The profile allows a baseline to be set for the trial and used to ensure that all subsequent activities can be measured and qualified against the profile. The Study Rating Requirement Profile contains, at a minimum, the following information: the trial name; the rating scales used on the trial; the rater qualification requirements (by country); the status of scale qualification requirements; the Number of Sites; the number of qualified raters per site.

The trial team or other group then conducts a search for sites that are qualified to work on the trial, and updates the Study Rating Requirements Profile with the potential sites and the raters at those sites who have the appropriate experience.

According to a preferred embodiment of the invention, as sites are added to the trial, potential raters at the selected sites are notified of their qualification evaluation and are sent a link where they can access a web-site and enter and/or upload/fax their credentials into the System along with a copy of their Curriculum Vitae (CV). In the case where a rater already exists in the System and that rater is pre-qualified for the specific scale(s) from a previous evaluation, such a rater is notified of their automatic qualification to participate as a rater for the trial.

As raters enter or upload their qualifications, the System automatically evaluates each rater's submission and determines whether each rater is fully qualified or not, and flags each rater submission either for acceptance or further evaluation. In the present embodiment, qualified rater submissions still require a manual review by the trial team to ensure that each rater's CV matches the qualifications submitted. In an alternate embodiment, this CV to Qualification evaluation may be automated using electronic translation to convert scanned images of CV's into machine-encoded text thus eliminating even more manual work. A “Qualification Wizard” is a tool used in the System to aid in automating the reconciliation of the rater's credentials with the requirements of the study. It may be presented as a form to raters online by the System, and the System contains sufficient logic to process rater data in the Qualification Wizard in light of rater CV data, so as to present the Study Team with information as to how well each rater applying for the study satisfies the rater requirements.

If potential raters fail to submit their qualifications within a specified period of time, they are notified automatically via email that they need to complete the evaluation and should do so as soon as possible. These automatic reminders reduce the amount of manual tracking and follow-up required by the trial team. After a specified number of unsuccessful follow-up attempts, the trial team is notified via email that a manual follow-up is required.

As raters are evaluated, the Study Rater Requirements Profile for the trial is updated with the latest information. All of the qualification data is stored in a database for use by the trial team and for use on any future qualification attempts. A rater may, over time, increase their qualifications for one or more rating scales and may at some point become qualified to administer the scale, even if they don't meet the qualifications for the current trial.

The trial team can review the Study Rater Requirements Profile and determine how the rater selection for the study is proceeding. Once the specified number of sites and qualified raters is achieved, the trial team can cease their rater qualification efforts and focus other aspects of the trial requiring their attention. As the trial proceeds, additional qualification evaluations may be required as sites and raters drop out of the trial and these would follow the same process as outlined above.

With the inventive automated system, metrics regarding effort expended in rater selection and qualification effort can be generated to provide insight into the Rater Qualification process. Useful metrics are currently unavailable or difficult to obtain in the manual, paper based process.

As provided for in the preferred embodiment, for any future clinical trials, the trial teams can search the Rater Qualification Database for raters and sites that have already been qualified for the Rating Scales that will be used on the trial. In this way, the invention enables significant expediting of the Rater Qualification process and potentially shortening the site selection timeline for new trials.

Moreover, as raters participate in clinical trials, some or all of their ratings can be audio or video taped and subsequently evaluated by a blinded expert reviewer to determine interview quality and rater proficiency. The results of these evaluations can be tracked and each rater's Rater Qualification Profile is updated with his or her trial performance. In this way, tangible results can be gathered for future trials. The stored data can provide detailed insight into the efficacy of specific raters on specific trials and scales. The stored data aids in building a complete history together with specific rater's work and training qualifications. Additional training can then be prescribed for those raters who do not meet the level of proficiency required for clinical trials. Results of evaluations may also be used to evaluate and update the rater qualification itself, and ensure that the qualifications are commensurate with the skills and experience required to administer a specific scale.

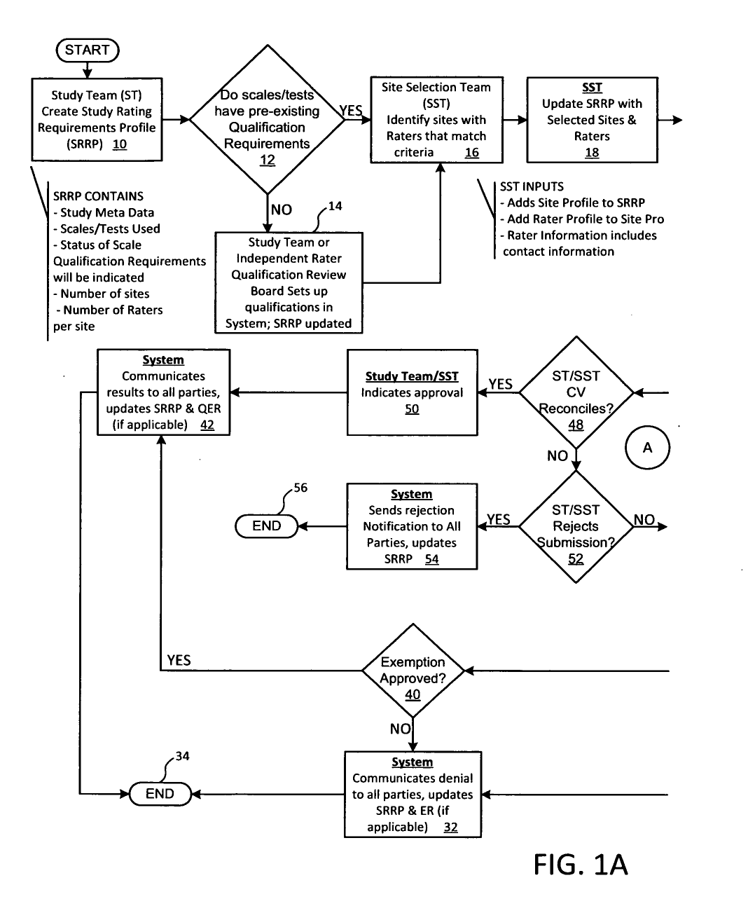

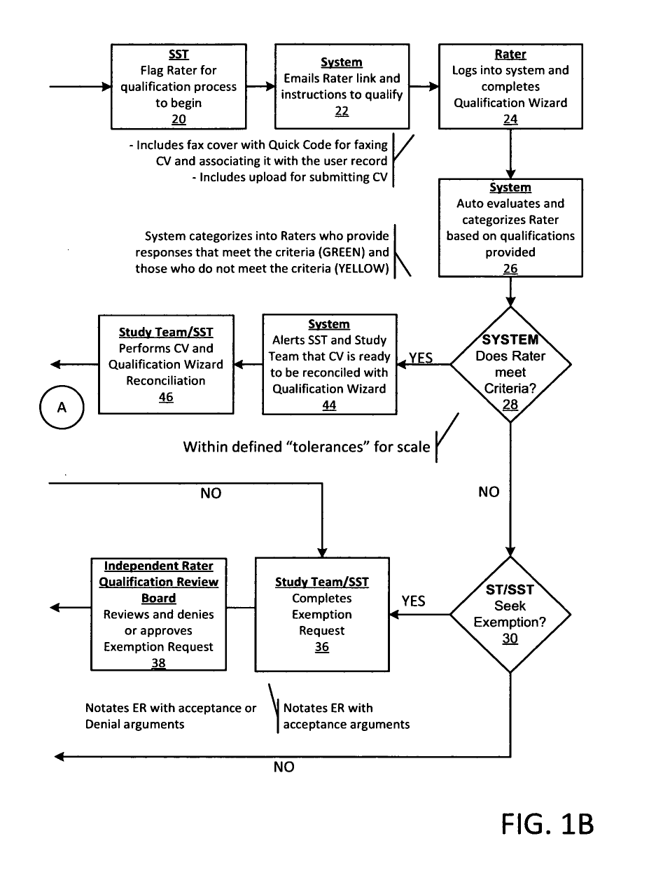

Referring to FIG. 1, the steps according to an embodiment of the invention are set forth. Unless otherwise stated, all action are taken by means of input to or output from the system, via some device coupled to or in communication with the system, or by the system itself, automatically, according to the logic and computer implementable instructions provided by the invention.

Step 10: create Study Rating Requirement Profile (SRRP). The SRRP contains: study meta data, scales and tests to be used in the study; an indication of the status of the scale qualification requirements; the number of sites; the number of raters per site.

Step 12: Determine: qualification requirements exist? Do scales and tests have pre-determined qualification requirements?

If yes to step 12, go to step 16, if no to step 12, go to step 14

Step 14: set up qualification requirements in system; update Study Rating Requirement Profile. Task typically performed by the Study Team or the Independent Rater Qualification Review Board.

Step 16 identify study sites (Sites): Identify Sites with raters that match criteria. The Site Selection Team (SST) adds Site profiles to the SRRP, and adds Rater profiles to the Site profiles.

Step 18: update SRRP with identified Sites and Raters. Step 18 is typically performed by the SST.

Step 20: Flag Raters for beginning qualification process. Step 20 is typically performed by the SST.

Step 22: contact Raters, emailing the Raters links and instructions to qualify. Step 20 is typically performed by the System. Instructions regarding how to qualify are embodied in an online form or application, referred to herein as a “Qualification Wizard”.

Step 24: Raters login to the System and complete the Qualification Wizard. Completing the Qualification Wizard typically includes a fax cover form with a “quick code” for faxing Rater curriculum vitae (CV) and associating the CV with the Rater's user record. An upload for submitting the Raters CV is also provided. Step 24 is performed by the Raters.

Step 26: Automatic evaluation and categorization of Raters based on the responses provided the Raters. In one embodiment, the System categorizes the Raters into two color categories: Raters who meet the criteria are displayed as Green, and Raters who do not meet the requirements are displayed as Yellow. The System performs step 26.

Step 28: Determine if a given Rater meets the criteria. For each Rater, the System applies tolerances for scale, and determines whether a Rater meets the criteria. If the answer is “yes” to step 28, then proceed to step 44. If the answer is “no” to step 28, then proceed to step 30.

Step 30: decide whether to seek an exemption. The Study Team and/or the Site Selection Team decide whether a Rater from step 28 who does not meet the criteria should be the subject of an exemption request. If “yes” then proceed to step 36. If “no”, proceed to step 32.

Step 32: if the answer to the question posed in Step 30 is “no”, then the System automatically sends a communication concerning the denial of that Rater to all interested parties; the System automatically updates the SRRP (Study Rating Requirements Profile) and, if applicable, the ER.

Step 34: END—no more steps are taken regarding that Rater.

Step 36: if the answer to the question posed in step 30 is “yes”, then an Exemption Request may be submitted with respect to the Rater under consideration. Typically, this step is performed by a member of the Site Team or the Site Selection Team.

Step 38: after step 36, the exemption request is reviewed, typically by the Independent Rater Qualification and Review Board, and it is determined whether to grant or deny the exemption request.

Step 40: If the result of Step 38 is that the Exemption is approved, then proceed to Step 42; if the result of Step 38 is that the Exemption Request is denied, then proceed to Step 32, whereupon the System communicates the denial, updates the SRRP and ER, and then proceeds to Step 34. In the case where the result of Step 38 is that the Exemption Request is approved, then proceed to Step 42.

Step 42: the System automatically generates a communication that the exemption request has been granted, and updates the SRRP and, if applicable, the ER. The next step is Step 34—END—no more steps regarding that Rater.

Step 44: if the response to the question posed in Step 28 is “yes” (i.e. the Rater meets the criteria) the System automatically generates an alert to the Site Selection Team and the Study Team, informing them that the Rater CV is ready to be reconciled with the Qualification Wizard.

Step 46: after receiving the alert of step 44, the Study Team and/or the Site Selection Team perform the reconciliation of the Rater CV and the Qualification Wizard. Proceed to Step 48.

Step 48: taking the output of Step 46, the Study Team and/or the Site Selection Team determine of the Rater CV is reconciled with the Qualification Wizard. If the determination is “yes” then proceed to step 50; if the determination is “no”, then proceed to step 52.

Step 50: receiving the output of step 48, indicating the Rater CV reconciles with the Qualification Wizard, the Study Team and/or the Site Selection Team indicate approval of the Rater, and then proceed to Step 42.

Step 52: receiving the output of step 48, indicating the Rater CV does not reconcile with the Qualification Wizard, the Study Team and/or the Site Selection Team decides whether to reject the Rater, and proceed to step 54, or to complete an exemption request, and go to step 36.

Step 54: receiving output of step 52, the System generates a rejection notification of the Rater in question, sends the rejection notification to all parties concerned, updates the SRRP, and proceeds to step 56.

Step: 56 End—no more steps taken with regard to that Rater.

It should be appreciated that it is not possible to recite every embodiment of the method set forth herein. The embodiment set forth above represents a near term implementation, and includes some degree of human-computer interaction on the part of clinical trial administrators or other staff. The advantage to this embodiment is that it can be implemented without large expenditures from clinical trial sponsors and can produce cost savings associated with improved expedition in the launching of clinical trials.

In addition to expedition of clinical trial launch, it bears repeating that the standardization of rater qualification as provided by the inventive method contributes significantly to the quality of the results of any clinical trial or study.

We claim:

1. An improved method of qualifying raters for participating in a clinical trial, said method comprising the steps of evaluating rater applications for participation as raters in a clinical study, where said evaluation includes assessing the match between the scale requirements set for the scales used in the clinical trial with the rater qualifications, and determining whether a rater satisfies said scale requirements, said improvement comprising the steps of:
applying, said applying using a computational device upon which logic and computer-implementable steps have been loaded into memory, said computational device in communication with input and output devices, where said input and output devices include human user interfaces, a comparison of rater qualifications against scale requirements;
determining the extent to which rater qualifications satisfy scale requirements; and
determining, if any scale requirements remain to be satisfied, the appropriate test that would, upon rater passing said test, would qualify said rater; and
communicating said determinations to parties responsible for said clinical study, thereby contributing to an expeditious launch of said clinical trial.

2. The improved method of claim 1, further including the step of determining, when one or more scale requirements remain to be satisfied, the most rapid course of action that would qualify said rater.

3. The improved method of claim 1, further including the step of storing all data for all rater applicants, including results of rater test activity, said stored data amenable to retrieval and analysis, so that parties responsible for said clinical study are apprised real-time of the status of rater qualification, enabling an expeditious launch of said clinical trial.

4. The improved method of claim 1, wherein the step of determining the extent to which rater qualifications satisfy scale requirements further includes accommodating scale requirement variations particular to geographic regions.

5. The improved method of claim 1, wherein the step of communicating said determinations of scale requirements to be satisfied by rater further includes providing aggregate information indicating the status of all raters and for all clinical trial sites.

6. The improved method of claim 1, wherein the step of determining, if any scale requirements remain to be satisfied, the appropriate test that would, upon rater passing said test, qualify said rater, further includes the sub-step of determining whether an exemption for said scale requirement is appropriate to request.

7. The improved method of claim 1, wherein the step of applying, said applying using a computational device upon which logic and computer-implementable steps have been loaded into memory, said computational device in communication with input and output devices, where said input and output devices include human user interfaces, a comparison of rater qualifications against scale requirements, further includes a comparison of rater qualifications against a Study Rating Requirement Profile, where said Study Rating Requirement Profile includes: the trial name; the rating scales used on the trial; the rater qualification requirements (by country); the status of scale qualification requirements; the number of sites; the number of qualified raters per site.
